(19) United States
(12) Patent Application Publication
(10) Pub. No.: US 2026/0360277 A1
(43) Pub. Date: Nov. 12, 2026

(54) ELECTROMECHANICAL REFRESHABLE BRAILLE DEVICE, SYSTEM AND METHOD

(71) Applicants: Enan Srivastava, Columbus, OH (US); Alyssa Jarvis, Ashland, OH (US); Caroline Karbowski, Montgomery, OH (US); Garrett Carder, Salt Lake City, UT (US)

(72) Inventors: Enan Srivastava, Columbus, OH (US); Alyssa Jarvis, Ashland, OH (US); Caroline Karbowski, Montgomery, OH (US); Garrett Carder, Salt Lake City, UT (US)

(21) Appl. No.: 19/076,917

(22) Filed: Mar. 11, 2025

Related U.S. Application Data
(60) Provisional application No. 63/718,623, filed on Nov. 9, 2024.

(51) Int. Cl. G09B 21/02

(52) U.S. Cl. CPC G09B 21/02

(57) ABSTRACT

A refreshable braille device (RBD), incorporating refreshable braille technology (RBT), the device or system operable to collect text in ASCII format from an external data processing device (DPD) and parse the ASCII text into strings, the RBD comprising one or more microcontrollers per braille cell, and a plurality of braille cells comprising two stepper motors, cams, and pins in some embodiments. In some embodiments, the braille cell is detachably affixed to a control board. A plurality of braille cells may form a braille array or RBD.

### BACKGROUND OF THE INVENTION

### Field of the Invention

This invention relates to reading devices for the visually impaired and more particularly relates to refreshable braille devices.

### Description of the Related Art

Refreshable braille technology (RBT) includes tactile apparatuses with undulating pins to enable people who are blind or have low vision (BLV) to read characters tactilely. The raised pins or dots are arranged within braille cells, typically comprising six or eight pins arranged in two columns and three or four rows.

Existing RBT is expensive to manufacture, purchase and maintain, mainly due to the cost of standard braille cells averaging several hundred dollars a cell; putting these devices beyond the reach of many BLV individuals, 90% of whom live in a low-income setting. There are an estimated 295 million people globally who have moderate to severe vision impairment and approximately 43.3 million more who are completely blind.

The estimated number of people with blindness in the U.S. is expected to double by 2050, and with more than 50% of the U.S. population with a visual impairment not in the labor force compared with fewer than 25% of people without disabilities, there is a major opportunity in this population for employment. In a 2024 study of employed blind participants, two-thirds of the participants used braille at their job, with more than half utilizing refreshable braille technology. In the Digital Era, text-to-speech and recordings assist BLV people in interacting with new information, but users benefit more in grammar, spelling and by extension, job opportunity through braille literacy.

Additionally, there are not efficient refreshable braille devices known in the art which function both as accessory devices to external computers and data processing devices (DPDs) and also as standalone computing devices.

It is therefore desirable that an electromechanical, refreshable braille device be provided.

### SUMMARY OF THE INVENTION

From the foregoing discussion, it should be apparent that a need exists for a more efficient electromechanical refreshable braille display, system and method. Beneficially, such a RBT would overcome many of the above-summarized difficulties of the prior art. The present invention has been developed in response to the present state of the art, and in particular, in response to the problems and needs in the art that have not yet been fully solved by currently available apparati and methods. Accordingly, the present invention has been developed to provide a braille cell detachably affixable to a refreshable braille device, the braille cell comprising: a plurality of stepper motors oriented vertically, each stepper motor directly connected to a cam; a first cam comprising a concentric guide rail defining a plurality of recesses operable to reciprocate two pins, the guide rail forming an uninterrupted ring around a top surface of the first cam, the first cam operable to rotate unidirectionally; a second cam comprising two concentric guide rails defining a plurality of recesses operable to reciprocate four pins, the second cam operable to rotate unidirectionally; a top plate disposing over the first cam and the second cam, the top plate defining six or more apertures, each aperture dimensioned to contour an exterior surface of a pin; six or more reciprocating pins, each pin resting on a guide rail, each reciprocating vertically within an aperture.

The braille cell may further comprise a vertically-oriented bracket affixable to one or more of the stepper motors. The apertures may be cylindrical. A second braille cell detachably affixable to a refreshable braille display is provided, the braille cell comprising: between two and four stepper motors oriented vertically, each stepper motor directly connected to a cam; between two and four cams, each cam comprising a concentric guide rail defining a plurality of recesses operable to reciprocate two pins, the guide rail forming an uninterrupted ring around a top surface of the cam, each cam operable to rotate unidirectionally; a top plate disposing over the first cam and the second cam, the top plate defining six or more apertures, each aperture dimensioned to contour an exterior surface of a pin; six or more reciprocating pins, each pin resting on a guide rail, each reciprocating vertically within an aperture.

A third braille cell detachably affixable to a refreshable braille device is provided, the braille cell comprising: between two and four stepper motors oriented vertically, each stepper motor directly connected to a cam; between two and four cams, each cam comprising a concentric guide rail defining a plurality of recesses operable to reciprocate a plurality of pins, the guide rail forming a plurality of protuberances operable to raise a superiorly-resting pin, the protuberances comprising a top surface; a top plate disposing over the first cam and the second cam, the top plate defining six or more apertures, each aperture dimensioned to contour an exterior surface of a pin; eight reciprocating pins, each pin resting on a guide rail, each reciprocating vertically within an aperture; a microcontroller; one of a bracket and housing operable to interconnect the braille cell detachably into a larger braille array.

The top surface of the protuberance may define a concave divot. The pins may comprise a flange and lower cylindrical member. Each lower cylindrical member may define a hollow interior recess housing a lubricant, each lower cylindrical member affixed to a bearing at a lower surface, the bearing operable to roll and reduce friction across a protuberance.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side perspective view of a braille cell in accordance with the present invention;

FIG. 2A is a sectioned, side perspective view of a braille cell in accordance with the present invention;

FIG. 2B is an isometric perspective view of a braille cell in accordance with the present invention;

FIG. 2C is a sectioned, side perspective view of a pin of a braille cell in accordance with the present invention;

FIG. 3A is an isometric perspective view of a braille cell in accordance with the present invention;

FIG. 3B is an isometric perspective view of a braille cell in accordance with the present invention;

FIG. 3C is an isometric perspective view of a braille cell in accordance with the present invention;

FIG. 3D is an isometric perspective view of a braille cell in accordance with the present invention;

FIG. 4 is a top perspective view of a braille cell in accordance with the present invention;

FIG. 5 is a top perspective view of a braille cell in accordance with the present invention;

FIG. 6 is an isometric perspective view of pin of a braille cell in accordance with the present invention;

FIG. 7A is a side perspective view of a braille cell showing a PCB board in accordance with the present invention;

FIG. 7B is a side perspective view of a detachable braille cell in accordance with the present invention;

FIG. 7C is a side perspective view of a detachable braille cell in accordance with the present invention;

FIG. 7D is a side perspective view of a detachable braille cell in accordance with the present invention;

FIG. 7E is a side perspective view of a detachable braille cell in accordance with the present invention;

FIG. 8 is a side perspective view of PCB board of board layout of a stepper motor bracket of a braille cell in accordance with the present invention;

FIG. 9A is a data flow diagram of a refreshable braille device in accordance with the present invention;

FIG. 9B is a data flow diagram of a refreshable braille device in accordance with the present invention;

FIG. 10 is a block diagram of a system for refreshing a braille device in accordance with the present invention;

FIG. 11 is a schematic representation of dual and single stepper motor drivers in accordance with the present invention;

FIG. 12 is an electrical schematic showing current flow through a DC/DC boost converter shown with a switch in the on position in accordance with the present invention;

FIG. 13 is an electrical schematic showing current flow through a DC/DC boost converter shown with a switch in the off position in accordance with the present invention;

FIG. 14 is a half-stepping motor sequence created by manipulating the current direction through bipolar stepper motor windings in accordance with the present invention;

FIG. 15 is a flowchart of the steps of a method of displaying refreshable braille in accordance with the present invention; and

FIG. 16 is a flowchart of the steps of a method of displaying refreshable braille in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention such as a full braille display and single braille display. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

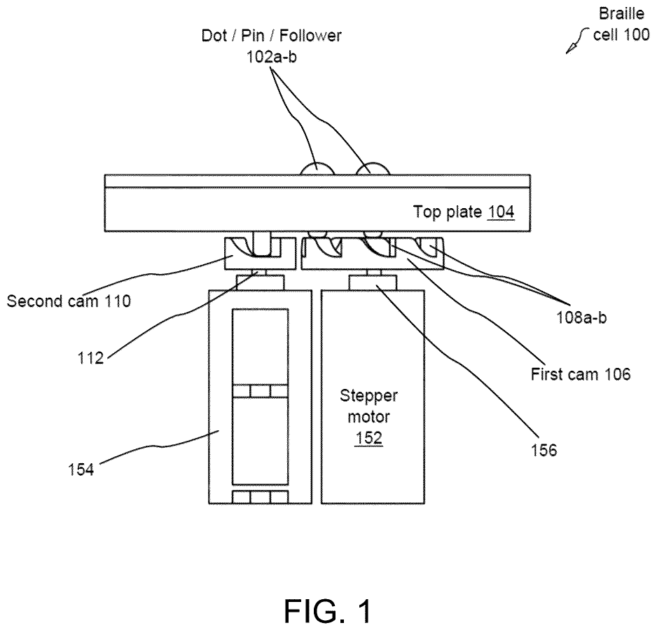

FIG. 1 is a side perspective view of a braille cell 100 in accordance with the present invention.

The braille cell 100 comprises a planar top plate 104 which may be fabricated from polymeric or metal alloy materials. The top plate 104 defines six apertures through which pins 102 protrude having convex top surfaces 604, the pins reciprocate within the top plate 104 and are raisable by the cell 100 to form characters from a braille writing system. This system has 64 possible combinations of zero to six raised dots to represent alphanumeric characters and symbols.

The cell 100 comprises two stepper motors 152 which rotate cams 110, 108. The first stepper motor 154 rotates a second cam 110, which is a smaller cam operable to actuate two pins 102. The second stepper motor 152 axially rotates a first cam 106 which comprises two raised circular guides 204, each circular guide 204 in contact with two pins 102. The guides 204 define a plurality of recesses 108 within which the pins 102 fall when a recess 108 is positioned beneath a pin 102. The recesses 108 define inclined surfaces 206 which act to raise a pin 102 when the cam 106 is axially rotated against a lower rounded edge 612 of the pin 102. In some embodiments, only one side of the recess 108 is inclined and consequently, the cams 110, 108 are operable only unidirectionally (either clockwise or counterclockwise).

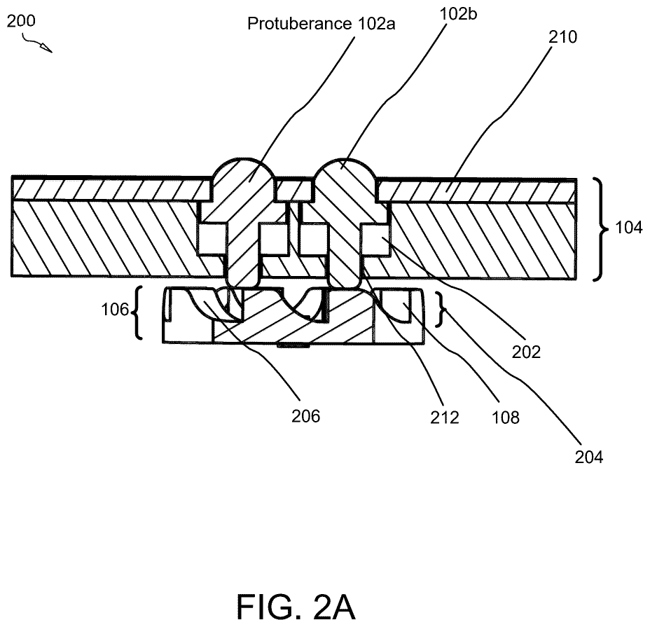

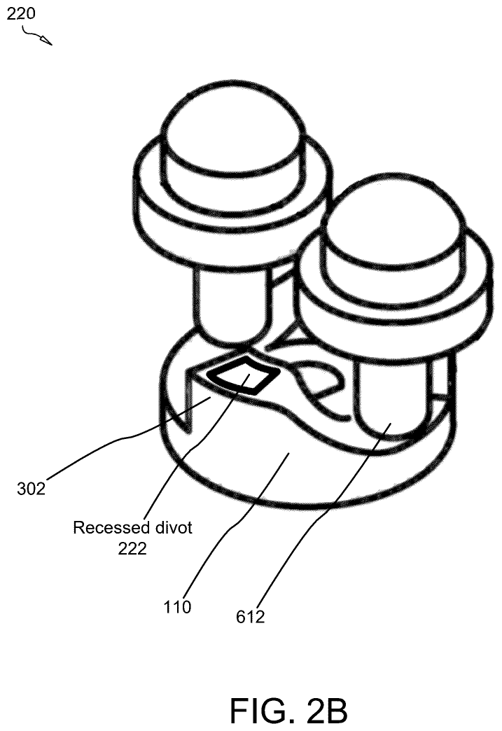

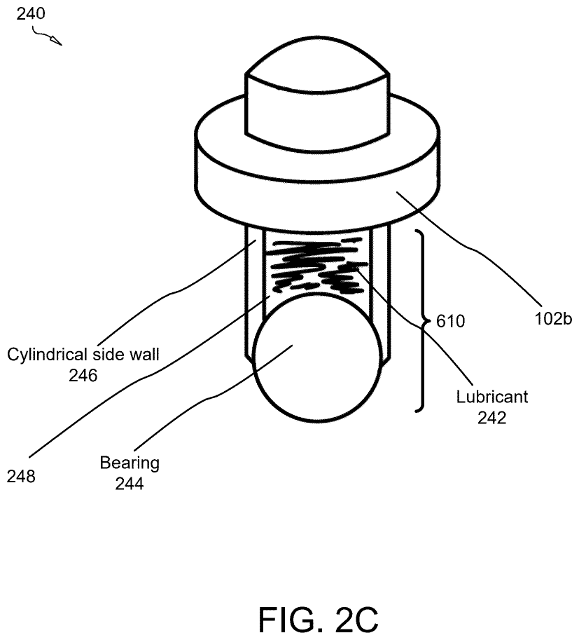

FIG. 2A is a sectioned, side perspective view of a braille cell 200 in accordance with the present invention.

In various embodiments, the cell 200 comprises a top plate 104 having a waterproof laminate, coating, or polymeric film 210 disposed thereover to prevent liquid, dirt and contaminates from a user's 904 fingers from seeping into the cell 200 mechanism and contaminating it.

The top plate 104 defines six or more cylindrical apertures 202 in which the pins 102 reciprocate vertically. The pins 102 may comprise a flange 606 which circumscribes the pin 102 laterally which flange 606 diametrically fills the recess 202.

The cylindrical recesses 202 have a lower floor which defines a smaller aperture 212 through which, and into which, the lower cylindrical body 610 of the pins 102 inserts, coming into contact with the cams 110, 108 thereunder.

FIG. 2B is an isometric perspective view of a braille cell in accordance with the present invention.

The guide on the cam 110 comprises a plurality of protuberances 302. In various embodiments, the top surface 224 of the protuberances 302 may comprise a concave divot 222, recess, aperture, channel or bore in which the lower, rounded surface 612 of the pin rests in a raised position.

FIG. 2C is a sectioned, side perspective view of a pin 240 of a braille cell in accordance with the present invention.

In various embodiments, the lower pin body 610 is hollow, defining a hollow interior recess operable to house a lubricant 242. The lower pin body 610 in this embodiment comprises a sidewall 246 defining an open bottom end into which a bearing 244 or ball disposes. The bearing 244 may be affixed using a snap fit or other means known to those of skill in the art.

The bearing 244 increases life expectancy of the pin 240 and braille cell incorporating the pin 240 by reducing friction between the lower rounded surface 612 of the pin 240 and the top surface of the protuberance 302.

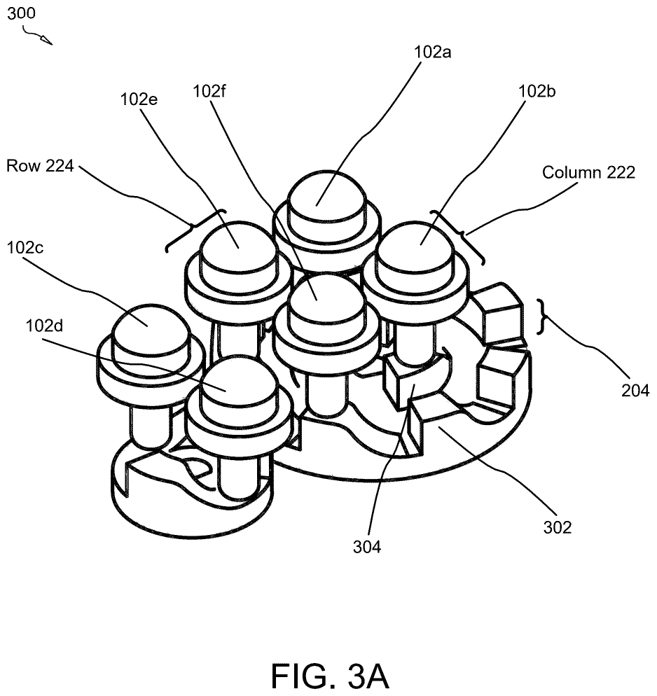

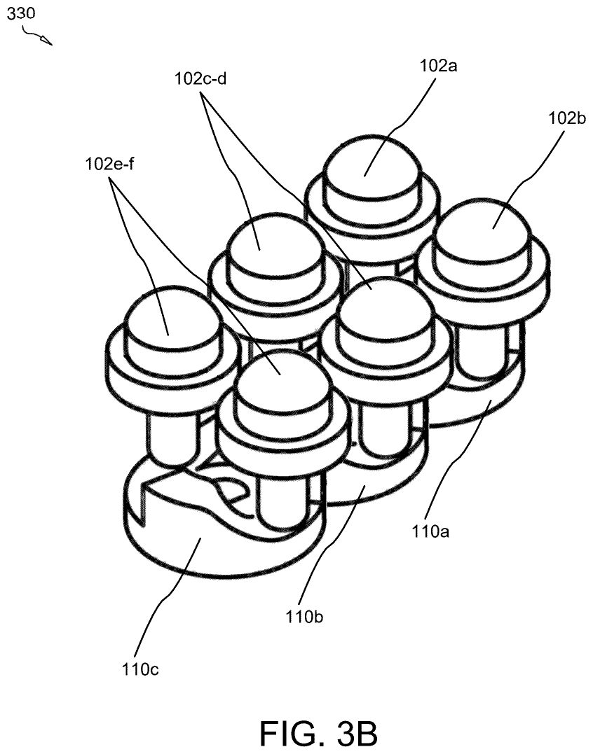

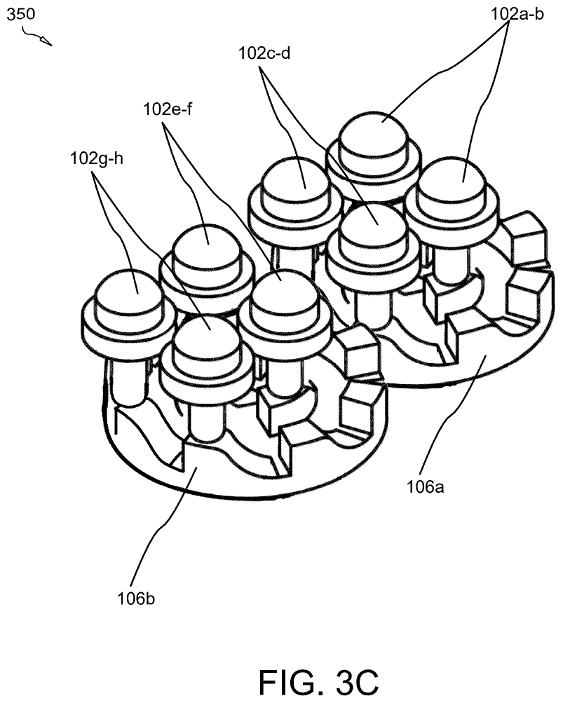

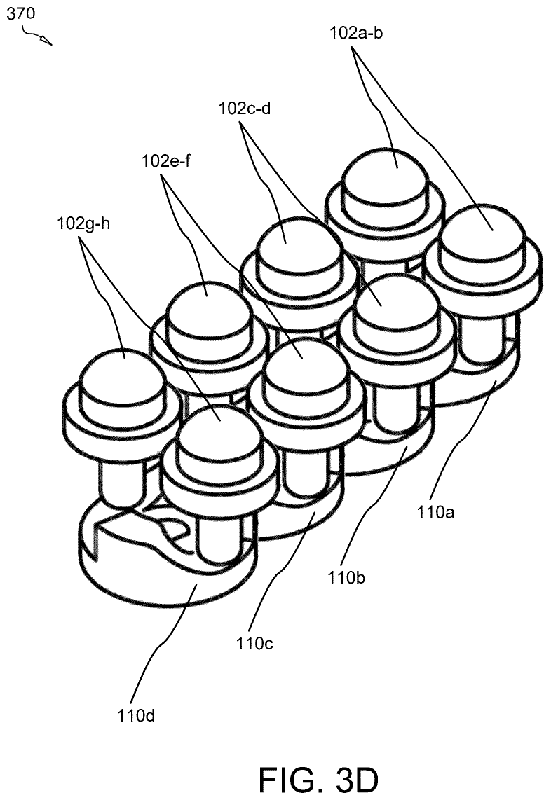

FIG. 3A is an isometric perspective view of a braille cell 300 in accordance with the present invention.

The pins 102 are oriented within rows 224 and columns 222 to form the Braille cell 300 and display collectively each of the 64 Braille characters.

In the shown embodiment, the second cam 108 defines a plurality of outer protuberances 302 which rotate to raise and lower pins 1023-f, and also a plurality inner protuberances 304 which rotate to raise and lower pins 102a-b.

FIG. 3B is an isometric perspective view of a braille cell 330 in accordance with the present invention.

In the shown embodiment, the cell 330 comprises three cams 110 in place of the embodiment shown in relation to FIG. 1 including a cam 110 and a cam 106. Each of the pins 110a-c are operable to actuate two pins 102, with each cam 110a-c rotating axially above a separate stepper motor 152.

FIG. 3C is an isometric perspective view of a braille cell 350 in accordance with the present invention.

In some embodiments, the braille cell 350 comprises an eight-pin system instead of a six. In these embodiments, the pins 102a-h may be actuated by two cams 106a-b. The braille cell 350 may comprise or consist of two cams 106a-b, each actuating a set of four pins 102. The braille cell 370 in this embodiment would include two stepper motors 152.

FIG. 3D is an isometric perspective view of a braille cell 370 in accordance with the present invention.

In still further embodiments, the braille cell 370 comprises or consists of four cams 110, each actuating two pins 102. The braille cell 370 in this embodiment would include four stepper motors 152.

FIG. 4 is a top perspective view of a braille cell 400 in accordance with the present invention.

As shown, the second cam 108 defines an aperture 406a while the first cam 110 also defines an aperture 406b. These apertures 406a-b comprise semi-circular through holes operable to mate with a similarly-contoured drive shaft, rod or pin operably connected to a stepper motor 152, 154 and to prevent slippage of the cam 110, 108 around said drive shaft 112.

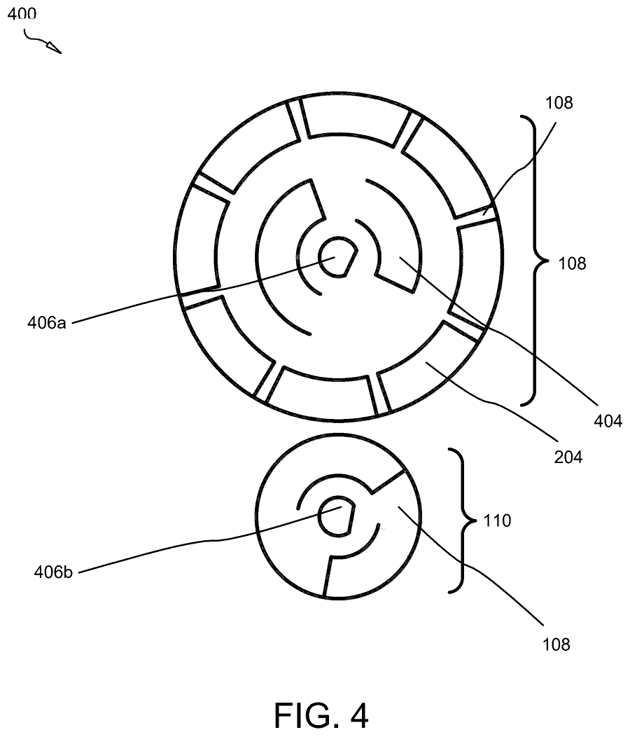

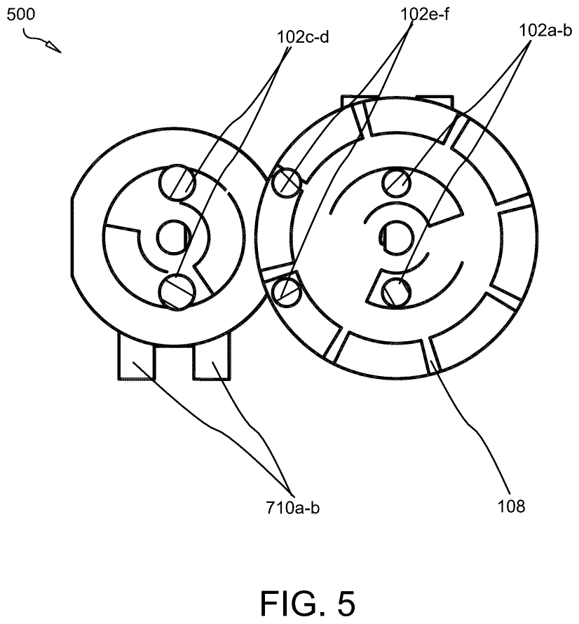

FIG. 5 is a top perspective view of a braille cell in accordance with the present invention.

In various embodiments, prongs 710 (i.e., connector pins) or mounting brackets protrude laterally from one or more of the stepper motors 152, 154 to engage a bracket for mounting the cell 500 with a larger cell array 902.

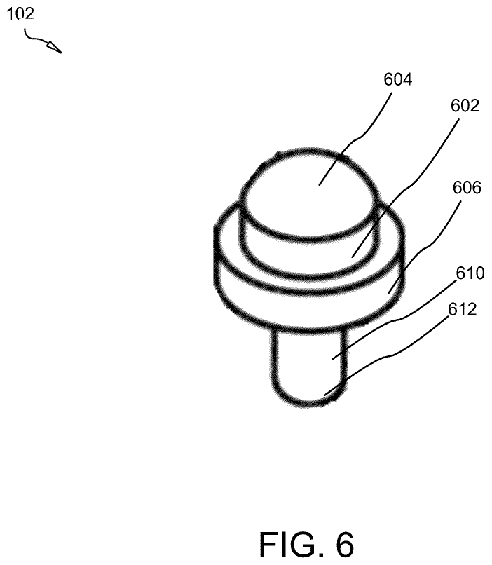

FIG. 6 is an isometric perspective view of pin 102 of a braille cell in accordance with the present invention.

The pin 102 comprises a convex top surface 604, an upward-protruding protuberance 602, a flange 606, a lower cylindrical member 610 and a rounded lower surface 612.

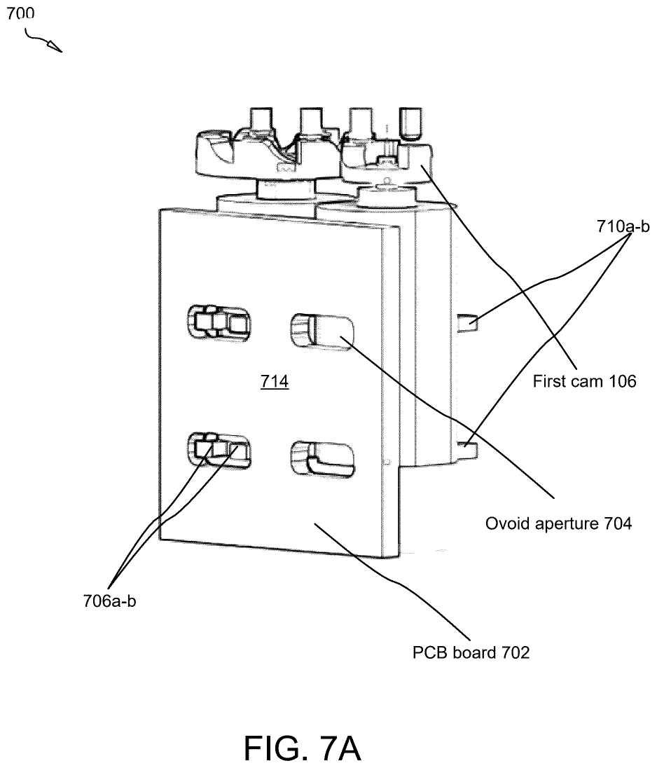

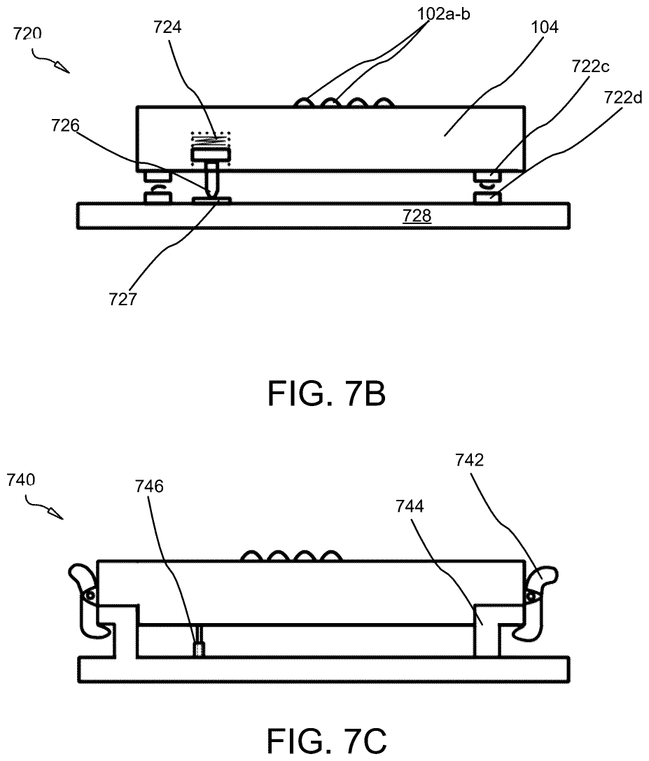

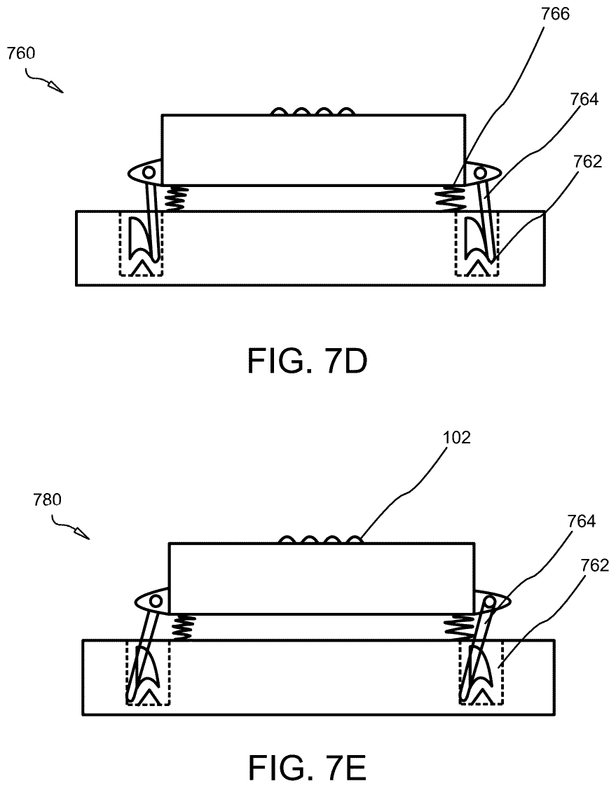

FIG. 7A is a side perspective view of a braille cell 700 showing a PCB board in accordance with the present invention.

The bracket 14 comprises a planar member of the braille cell 700 which comprises a PCB board 702. The bracket 714 comprises traces which connect, often using soldering, to the connector pins 710 protruding laterally from the stepper motors 154, 152.

The various embodiments, the connector pins 706 and prongs 710 are terms used interchangeably.

FIG. 7B is a side perspective view of a detachable braille cell 720 in accordance with the present invention.

The braille cell 720 comprises a top plate 104 and pins 102. The top plate 104 is detachable to a cradle, baseplate, or control board 728. In various embodiments, a plurality of braille cells constituting a braille array are detachably affixed to the control board 728.

The braille cell 720 may detachably affix to the control board 728 using magnetic means. In various embodiments, the top plate 104 comprises magnets 722 adapted to form a magnetic fit with the control board 728.

In various embodiments, the top plate 104 and/or the control board 728 both comprise magnets 722. These magnets 722, for instance 722c and 722d, form a magnetic force between them and facilitate detachable affixation of the top plate 104 to the control board 728.

In various embodiments, electrical connectivity between the top plate 104 and the control board is established through a protruding plug or pin 726 which is spring-biased into a downward position using a spring 724 positioned above the pin 726 which comes into direct contact with a connective plate 727 on the control board 728.

FIG. 7C is a side perspective view of a detachable braille cell 740 in accordance with the present invention.

In various embodiments, the control board 728 comprises a plurality of L-shaped brackets 744, each pair of L-shaped brackets forming a cradle into which the braille cell 740 positions. Lever arms 742 may be hingedly affixed to the top plate 104 for forming a snap fit with the brackets 744.

A conductor for establishing electrical connectivity between the braille cell and the control board 728 may jut inferiorly from the top plate 104 and form a physical electrical connection with the control board 728.

FIG. 7D-7E illustrate side perspective views of a detachable braille cell 760 in accordance with the present invention.

In various embodiments, the control board 728 defines a plurality of recesses 762 housing mechanical means of securing and releases a lever arm 764 when depressed. The lever arms 764 may articulate and/or be hingedly affixed to the top plate 104. In various embodiments, one or more springs 766 dispose between the braille cell 760 and the control board 104.

As shown in FIG. 7D-7E, the top plate 104 may be operable to press in or press out of the control board 728. The lever arms 764 may press into a friction fit with the control board 728 and then be pressed again to release the friction fit.

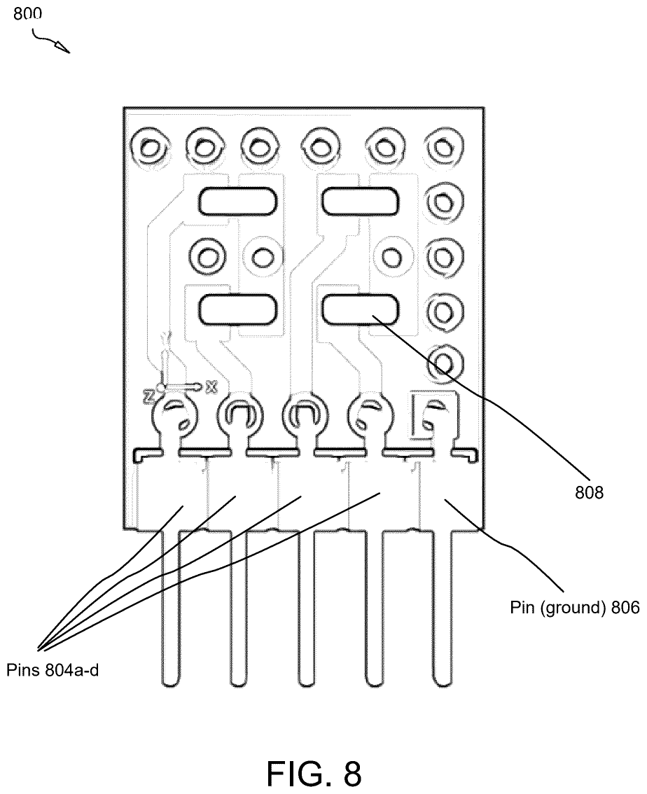

FIG. 8 is a side perspective view of the PCB board of board layout of a stepper motor bracket of a braille cell in accordance with the present invention.

Pins 804a-b supply stepper motor power while pin 806 is a ground in the shown embodiment.

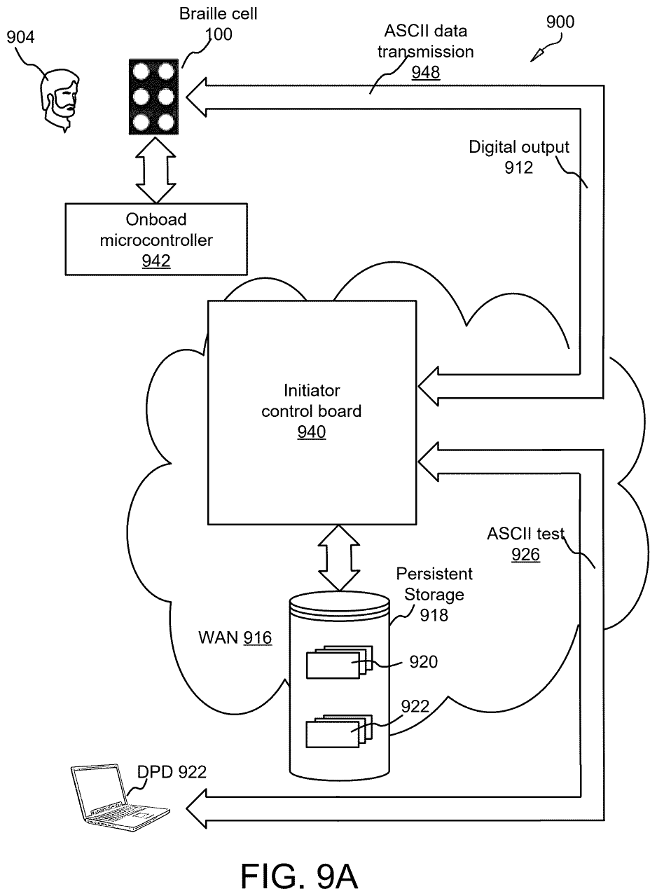

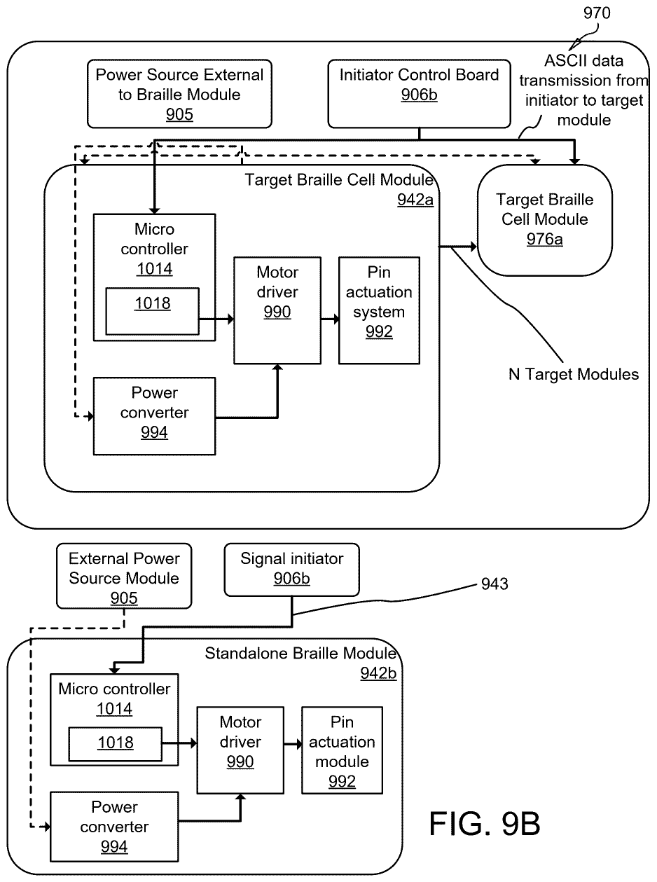

FIG. 9A is a data flow diagram of a refreshable braille device 900 in accordance with the present invention.

In various embodiments in which the microcontroller(s) 942 comprise one or more microcontroller(s), the microcontroller(s) 942 may run a code file to send a digital write command to the GPIO (general purpose input/output) pins.

The microcontroller 942 may include wired and wireless connectivity options in some embodiments, and may comprise a board or chip incorporable into the larger board 940 of the RBT 900.

The RBD 900 may comprise a digital I/O expander operable to increase the number of digital pins. Because the braille cell array may be operable to comprise any number of braille cells, including 14, 20, 28 or 40 or more, braille cells 100 each comprising four control pins 706, 56 digital output pins are needed.

The RBD 900 may use only a single output pin, sending data in Inter-Integrated Circuit (I²C) protocol in some embodiments, to send data to a board and/or the braille cell 100 or a braille cell array which is parseable into 56 digital output pins using a parsing module within the board 940 formed either from computer-readable instructions (i.e., software) or from firmware or hardware incorporated into the board 940.

The RBD 900 may additionally comprise a power regulation IC (such as TPS7894 in one embodiments), a USB connector (such as a USB-C), an actuation driver (such as DRV8836DSSR in an exemplary embodiment), an analog to digital converter (such as ADS10151DGSR), a microphone integrated into the RBD 900 or DPD 922, a microphone amplifier, speakers, and audio amplifier (such as PAM8304AYR).

The I²C operates at 100 kbps.

The braille cell array may incorporate tactile menus operable to receive input from the user 904 as further described below. This input is relayed back to the board 940 and to the DPD 922.

FIG. 9B is a data flow diagram of a refreshable braille devise 970 in accordance with the present invention.

Any N number of braille cells 942 may be integrated into a larger braille device 970. The braille device 970 may include, consist of, or comprise an initiator control board 906, a power source. The initiator control board 906b may be adapted to send ASCII text display commands (including ASCII characters) to the target braille module 942 via an electrical communication protocol.

Optionally the braille cells may operate as a standalone component 942b, with the optional inclusion of a power converter 994 within the braille module 942.

Remainder as shown.

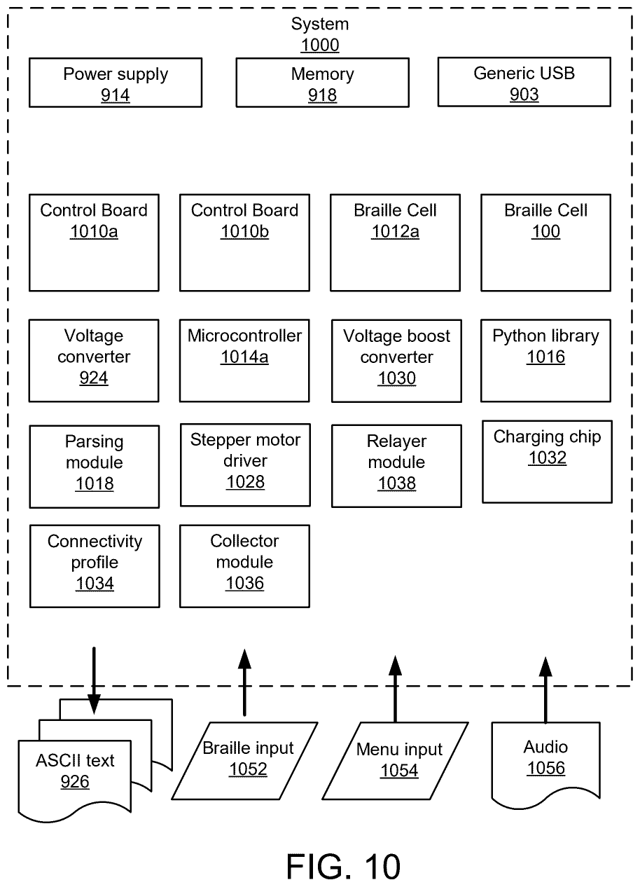

FIG. 10 is a block diagram of a system for refreshing a braille device in accordance with the present invention.

The microcontrollers 1014a-b may comprise a Raspberry Pi Zero W in some embodiment. In alternative embodiments, the microcontrollers 1014a-b comprise other microcontrollers such as an AML-S905X-C C (Le Potato) or a BeagleBoard™.

The system 1000 may comprise a generic USB port 903.

The parsing module 1018 may be configured to parse the ASCII text 926 into strings of characters, each string exclusively associated with a braille cell 1012.

The microcontroller 1014 may optionally include a parsing module 1018.

In various embodiments, the system 1000 comprises one more control boards 1010, a voltage converter 924, a voltage boost converter 1030, a python library 1016 existing as instructions in computer-readable memory, one or more stepper motor drivers 1028, a relayer module 1038 adapted to relay text formatted in accordance with the American Standard Code for Information Interchange (ASCII) to a braille cell 100 or braille cell array, a charging chip 1032, a connectivity profile 1034, and a collector module 1036 configured to collect and store ASCII text 1052 input tactilely on a braille cell.

In various other embodiments, the braille array may comprise a microphone for receiving audio 1056 which is then sent to the system 1000 for processing or interleaving. The braille cell 100 may comprise a menu configured to receive and send menu input 1054 in a data stream to the system 1000.

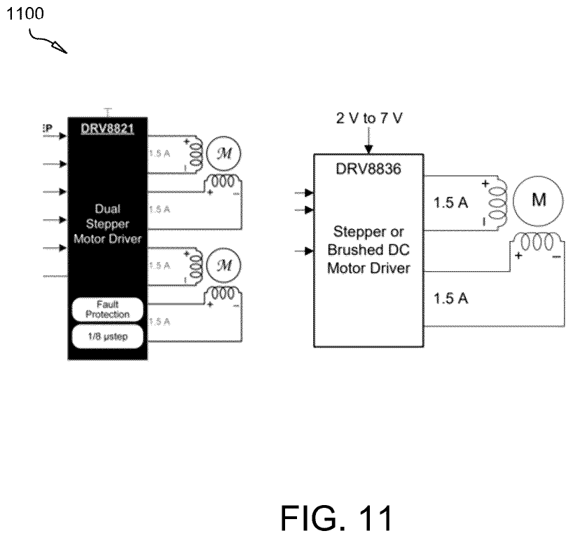

FIG. 11 is a schematic representation of dual and single stepper motor drivers in accordance with the present invention.

Each motor has an individual stepper motor driver to enable bidirectional current drive needed for half-stepping without incurring the high costs of dual stepper motor drivers. Additionally or alternatively, in place of stepper motors, each braille cell may have a servo with a limit switch. The selected driver comes with tradeoffs because it increases layout complexity of the motor drivers due to the large number of required digital inputs needed for driver control.

The system 900, 1000 may require two or more stepper motors in each of the braille cells. The dual stepper motor driver (e.g., DRV8821) may require 14 total drivers, and the single stepper motor driver may (e.g., TB 6612FNG) may require 28 total drivers.

The system 900 may comprise a LiPo Battery selected to achieve high energy density in a lightweight and compact form factor. Many mobile devices such as phones, smartwatches, and tablets use LiPo batteries to meet the same needs as the braille display device.

The system 900 comprises a USB-C Connector operable to provide improved accessibility due to its symmetric plug design. Users 904 of the product/system 900 can easily charge the braille device/system 900 with an aftermarket USB-C cable if the included cable is lost, so this prevents device downtime for the user. A chip in this port may be configured to control the charge level induced into the system 900.

The system 900 may comprise an External Power Connector (JST) connector.

The system 900 may comprise a LiPo Battery Charging Integrated Circuit (IC). The sensitive chemistry of LiPo batteries requires special charging practices, so a small, low-cost LiPo battery charging integrated circuit may be included to safely charge the braille device battery and delegate the use of USB-C power over battery power when available. The charging IC used in the design comes with reverse current, short-circuit, and thermal protections to protect the battery, device, and user from hazardous battery conditions due to improper connection or other issues. The charging IC also uses a simple solution of precomputed discrete resistors to set the charging current limit and average current values. Other charging ICs use sophisticated buses such as I²C that require software code on a microcontroller to set the charging parameters. For this reason, the minor configurability benefits of a sophisticated charging IC were sacrificed for the simpler and more robust solution.

The system 900 may comprise a DC-DC Boost Converter. The voltage of the battery may not align with the required input voltage of the microcontroller. A DC-DC voltage converter may be needed to step the voltage up to an appropriate 5V from the 3.7V of the battery. This ensures that the microcontroller will have sufficient and proper voltage applied to its inputs. The boost converter operates on the principle that the voltage across an inductor is equal to the value of the inductor multiplied by the change in current across it. A switch in the circuitry is on a duty ratio timing, allowing an inductor to charge when the switch is on and unleash power to the desired load when the switch is off. The switching frequency is controlled to achieve the desired step-up voltage, and a large capacitor is placed in parallel with the load such that the output voltage is steady.

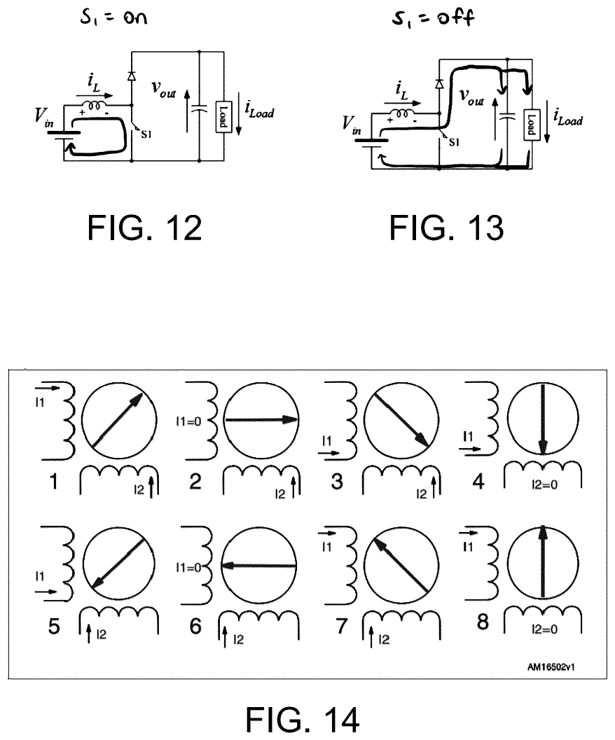

FIG. 12 is an electrical schematic showing current flow through a DC/DC boost converter shown with a switch in the “on” position in accordance with the present invention.

FIG. 13 is an electrical schematic showing current flow through a DC/DC boost converter shown with a switch in the “off” position in accordance with the present invention.

FIG. 14 is a half-stepping motor sequence created by manipulating the current direction through bipolar stepper motor windings in accordance with the present invention.

Stepper motors need directional current flow to create discrete steps in an open loop system. For this reason, the unidirectional current flow shown in FIG. 14 is not efficient for stepper motors and only useful for DC motors which lack accurate open loop control.

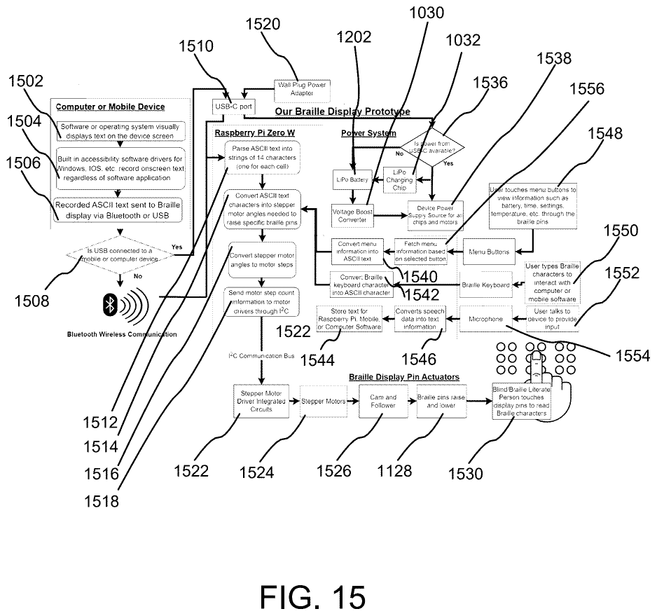

FIG. 15 is a flowchart of the steps of a method 1500 of displaying refreshable braille in accordance with the present invention.

In various embodiments, the method 1500 begins with text being visually displayed 1502 on display of GUI of a data processing device (DPD).

Built in drivers on the DPD 922 may be used to record and/or collect and/or convert text displayed on the graphic user interface (GUI) into text. In some cases, this text is recorded 1506 into a string in ASCII format and sent back from the braille device to the DPD.

If 1508 a refreshable braille technology (RBT) device is connected to the DPD 922 (in some cases, via a USB-C port 1510). The USB-C and/or the RBT may be connected to AC power from a plug 1520 in a wall or building.

In some embodiments, the character string and/or data collected from the DPD 922 is parsed (using a parser module 1018 in some embodiments) into strings. Each character may be exclusively intended for, and associated with, a braille cell 100 within a cell array 902.

Stepper motor angles may be converted 1516 to motor steps.

Using protocols in the art, such as I²C, motor step count information may be sent 1518 to motor drivers.

A battery 1202 may output power to a voltage boost converter 1030. The battery 1202 may be charged by a charging chip 1032. The battery 1202, in some embodiments, is only activated if 1536 power from a USB-C is unavailable. If power is available, the USB-C power is used to power the RBTD 1200.

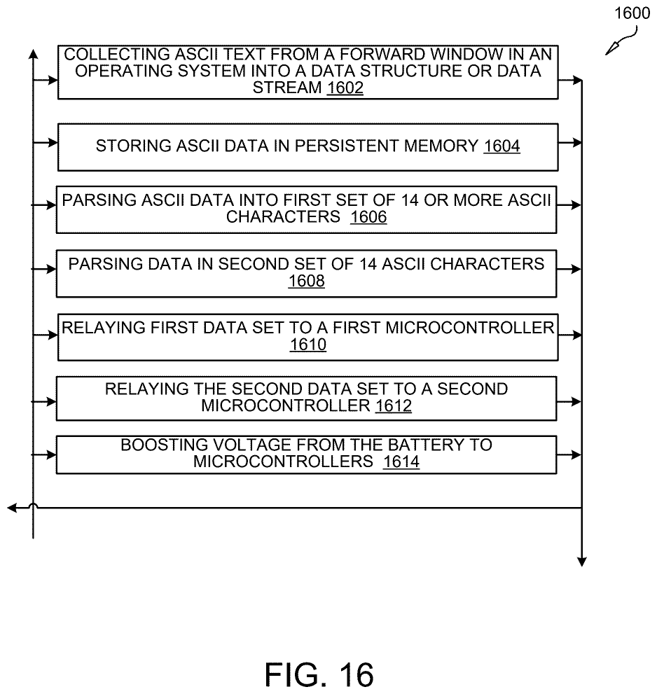

FIG. 16 is a flowchart of the steps of a method 1600 of displaying refreshable braille in accordance with the present invention.

In various embodiments, ASCII text is collected 1602 from a DPD 922, including from a window or computer application running on a DPD 922 within an operating system. This ASCII text is sent in a data stream 1052 to a board 940 and stored 1604 in persistent memory 918.

The parsing module 1018 may be used to parse 1606 a first set of the received ASCII text into data sent to the braille cell 100 or braille array in a format interpretable by a microcontroller 942 incorporated into the cell 100 to activate the cams and pins. Likewise, a second set of data may be parsed 1608 into 14 or more ASCII characters or into other formats for activating the braille cells.

The data in the first set is then relayed 1610 to one or more microcontrollers. The data in the second set, if any, may also be relayed 1612 to one or more microcontrollers.

Voltage from the battery to the cells 100 or arrays may be boosted 1614 using one or more voltage boosters.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A braille cell detachably affixable to a refreshable braille device, the braille cell comprising:
a plurality of stepper motors oriented vertically, each stepper motor directly connected to a cam;
a first cam comprising a concentric guide rail defining a plurality of recesses operable to reciprocate two pins, the guide rail forming an uninterrupted ring around a top surface of the first cam, the first cam operable to rotate unidirectionally;
a second cam comprising two concentric guide rails defining a plurality of recesses operable to reciprocate four pins, the second cam operable to rotate unidirectionally;
a top plate disposing over the first cam and the second cam, the top plate defining six or more apertures, each aperture dimensioned to contour an exterior surface of a pin;
six or more reciprocating pins, each pin resting on a guide rail, each reciprocating vertically within an aperture.

2. The braille cell of claim 1, wherein the pins comprise a flange and lower cylindrical member.

3. The braille cell of claim 2, wherein each lower cylindrical member defines a hollow interior recess housing a lubricant, each lower cylindrical member affixed to a bearing at a lower surface, the bearing operable to roll and reduce friction across a protuberance.

4. The braille cell of claim 1, further comprising a vertically-oriented bracket affixable to one or more of the stepper motors.

5. The braille cell of claim 1, wherein the apertures are cylindrical.

6. A braille cell detachably affixable to a refreshable braille device, the braille cell comprising:
between two and four stepper motors oriented vertically, each stepper motor directly connected to a cam;
a top plate disposing over the first cam and the second cam, the top plate defining six or more apertures, each aperture dimensioned to contour an exterior surface of a pin;
six or more reciprocating pins, each pin resting on a guide rail, each reciprocating vertically within an aperture.

7. The braille cell of claim 6, wherein between two and four cams, each cam comprising a concentric guide rail defining a plurality of recesses operable to reciprocate two pins, the guide rail forming an uninterrupted ring around a top surface of the cam, each cam operable to rotate unidirectionally.

8. The braille cell of claim 6, wherein the pins comprise a flange and lower cylindrical member.

9. The braille cell of claim 8, wherein each lower cylindrical member defines a hollow interior recess housing a lubricant, each lower cylindrical member affixed to a bearing at a lower surface, the bearing operable to roll and reduce friction across a protuberance.

10. A braille cell detachably affixable to a refreshable braille device, the braille cell comprising:
between two and four stepper motors oriented vertically, each stepper motor directly connected to a cam;
between two and four cams, each cam comprising a concentric guide rail defining a plurality of recesses operable to reciprocate a plurality of pins, the guide rail forming a plurality of protuberances operable to raise a superiorly-resting pin, the protuberances defining a top surface;
a top plate disposing over the first cam and the second cam, the top plate defining six or more apertures, each aperture dimensioned to contour an exterior surface of a pin; and
six or more reciprocating pins, each pin resting on a guide rail, each reciprocating vertically within an aperture.

11. The braille cell of claim 10, further comprising one of a bracket and housing operable to interconnect the braille cell detachably into a larger braille array

12. The braille cell of claim 10, wherein the top surface of the protuberance defines a concave divot.

13. The braille cell of claim 10, wherein the pins comprise a flange and lower cylindrical member.

14. The braille cell of claim 12, wherein each lower cylindrical member defines a hollow interior recess housing a lubricant, each lower cylindrical member affixed to a bearing at a lower surface, the bearing operable to roll and reduce friction across a protuberance.

15. The braille cell of claim 10, wherein the top plate comprises one or more magnets adapted to form a detachable magnetic fit with a control board into which the braille cell may be detachably set.

16. The braille cell of claim 10, further comprising one or more lever arms hingedly affixed adapted for detachably affixing to the control board.

17. The braille cell of claim 10, wherein the braille cell forms a snap fit with the control board using a plurality of lever arms.

18. The braille cell of claim 10, wherein the braille cell forms a snap fit with the control board.

19. The braille cell of claim 10, wherein the top plate comprises a spring-biased conductor for forming electrical connectivity with the control board.
